(19) United States
(12) Patent Application Publication
(10) Pub. No.: US 2002/0188644 A1
(43) Pub. Date: Dec. 12, 2002

(54) Workflow automated task component manager

(75) Inventor: Glenn R. Seidman, Woodside, CA (US)

Correspondence Address: MICHAEL B. EINSCHLAG, ESQ., 25680 FERNHILL DRIVE, LOS ALTOS HILLS, CA, 94024, US

(73) Assignee: Verano

(21) Appl. No.: 09/877,153

(22) Filed: Jun. 8, 2001

(51) Int. Cl. G06F 9/00

(52) U.S. Cl. 709/100; 709/101

(57) ABSTRACT

One embodiment of the present invention is a component manager that manages one or more workflow automated task components that implement an automated task in a workflow process definition running in a workflow engine, the component manager including: (a) a work coordinator that reads a workitem from a worklist in the workflow system and obtains a name of an automated task component and a method to invoke and workitem parameters; (b) a task translator that converts the workitem parameters into a method invocation on an automated task component instance representing the automated task; and (c) wherein the work coordinator synchronously waits for an invocation response before updating the workitem in the worklist.

### TECHNICAL FIELD OF THE INVENTION

The present invention pertains to component managers, components associated with the component managers, and methods and apparatus for fabricating the component managers and their associated components. In particular, the present invention pertains to a workflow automated task component manager (for example, a workflow automated task component manager embodied as an Enterprise Workflow AutomatedTaskBean container) and automated task components (for example, automated task components embodied as Enterprise AutomatedTaskBeans) associated therewith.

### BACKGROUND OF THE INVENTION

The need to manage a long running sequence of activities is commonplace in enterprise computing today. This long running sequence of activities is called workflow, and the description of information to maintain, the sequence, the decisions, and the activities to execute along with their parameters is known as a workflow process definition. At runtime, workflow process definitions get instantiated and maintain a runtime state corresponding to the information description in the workflow process definition.

The activity implementations fall into two categories: automated task and participant task. Automated tasks are activities that involve invocation of executable code involving no humans. Participant tasks are quite common in workflows because humans usually participate as the processing element in workflow activities. Real workflow systems, therefore, have worklists that participants browse to determine what to process next. When a running workflow process gets to the point in its process definition that it must execute a specific activity, the workflow process engine collects the name of the activity and its parameters and forms a workitem that is submitted to a worklist. It is at this point that participants browse the worklist to find a workitem to process. Automated tasks, on the other hand, just get invoked automatically since they don't care which workitem to work on next.

Corporations who deploy workflow systems, design workflow process definitions, but typically require the construction of custom activity implementations in order to make the workflow process definition actually be able to do real work. Today, workflow system providers offer software development kits with proprietary APIs for building custom workflow activities. Constructing a custom workflow activity involves writing to a custom API and requires time to learn.

In light of the above, there is a need for method and apparatus that can introduce custom activities with no special API, and instead allow activity implementations to be performed by standard components.

### SUMMARY OF THE INVENTION

Embodiments of the present invention advantageously satisfy the above-identified need in the art. In particular, one embodiment of the present invention represents a workflow automated task component manager (embodied, for example, as a container) that provides freely gained characteristics for workflow automated task management by associating components with the workflow automated task component manager (for example, by dropping the component into the container)—along with simple text declarations, representing workflow automated task manager instructions for each component (for example, set forth in a deployment descriptor). Advantageously, a workflow automated task component manager fabricated in accordance with this embodiment provides a simple, unified framework for implementing activity coordination with external software subsystems without a developer having to explicitly code to gain such advantages. Specifically, one embodiment of the present invention is a component manager that manages one or more workflow automated task components that implement an automated task in a workflow process definition running in a workflow engine, the component manager comprising: (a) a work coordinator that reads a workitem from a worklist in the workflow system and obtains a name of an automated task component and a method to invoke and workitem parameters; (b) a task translator that converts the workitem parameters into a method invocation on an automated task component instance representing the automated task; and (c) wherein the work coordinator synchronously waits for an invocation response before updating the workitem in the worklist.

### BRIEF DESCRIPTION OF THE FIGURE

FIG. 1 shows symbols used in the Detailed Description to describe various software entities and their interrelationships;

FIG. 2 shows various of the interrelationships shown in FIG. 1;

FIG. 3 shows a component deployment file;

FIG. 4 shows a block diagram of an XML grammar structure of an EWAT JAR that is fabricated in accordance with the present invention;

FIG. 5 shows a block diagram of typical Enterprise AutomatedTaskBeans of FIG. 3 that are deployed in an EWATB Container with a thread multiplicity that was designated in a Deployment Descriptor;

FIG. 6 shows a block diagram of how a single Workflow Process Engine may insert WorkItems into one of several Worklists; and

FIG. 7 shows a block diagram of software subsystems (along with their interrelationships) that comprise one embodiment of the present invention.

### DETAILED DESCRIPTION

In accordance with one embodiment of the present invention, a workflow automated task component manager enables software components developed according to a new design pattern to be deployed, and to enjoy advantages for activity coordination of custom processing without having to code explicitly to gain such advantages. In accordance with one or more embodiments of the present invention, the advantageously obtained advantages include transparent component method invocation by automated conversion of WorkItems into method invocations on workflow-unaware components, and transformation of single object return values into multiple output parameters.

In accordance with one embodiment of the present invention, an EWATB Container operates on a network server with a workflow process engine and worklist server residing in the same server. Further embodiments of the present invention cover situations where the workflow process engine resides in a distinct server.

An EWATB Container fabricated in accordance with the present invention provides a component manager in the form of a container architecture wherein components, for example, workflow automated task components may be deployed into the container to gain beneficial dynamics and services. In accordance with one embodiment of the present invention, contracts (for example: a container/component contract; a client/component contract; and a deployment contract) are specified by way of interfaces (the interfaces include an administrative user interface) and a deployment model.

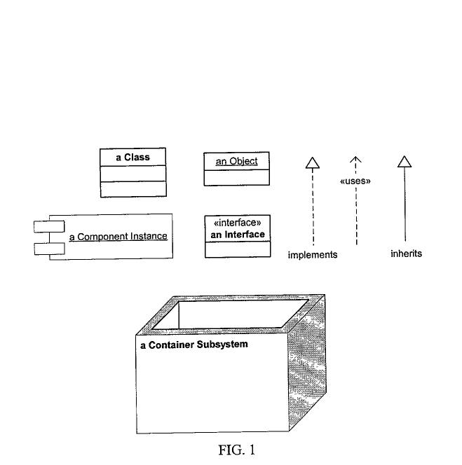

The following detailed description of embodiments of the present invention employs UML structure diagrams that are well known to those of ordinary skill in the art to describe various software entities and their relationships. Note, however, that the container subsystem symbol shown, for example, in FIG. 1, is not an UML standard, but it is used to better illustrate that some embodiments of the present invention comprise a container that “contains” components that get deployed thereinto.

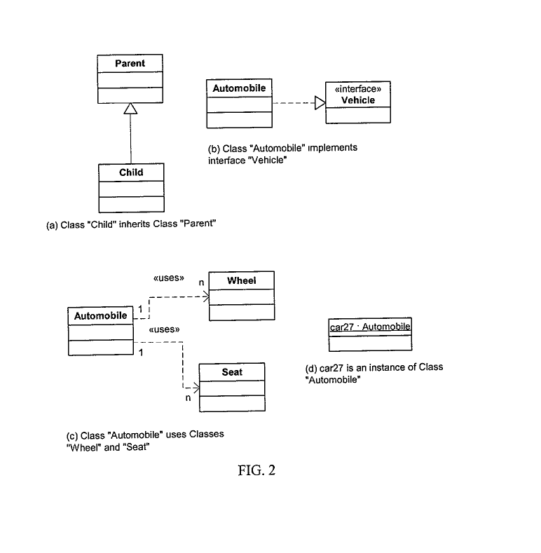

FIG. 1 shows the symbols used herein to describe various software entities and their interrelationships. As shown in FIG. 1, symbol 100 refers to a container subsystem, symbol 110 refers to a class, symbol 120 refers to a component instance, symbol 130 refers to an object, symbol 140 refers to an interface, symbol 150 refers to an interrelationship of “implements,”, symbol 160 refers to an interrelationship of “uses,” and symbol 170 refers to an interrelationship of “inherits.” FIG. 2 shows various of the interrelationships shown in FIG. 1. As shown in FIG. 2a, the class “child” inherits class “Parent.” As further shown in FIG. 2b, class “Automobile” implements interface “Vehicle.” As still further shown in FIG. 2c, class “Automobile” uses classes “Wheel” and “Seat.” Lastly, as further shown in FIG. 2d, car 27 is an instance of class “Automobile.”

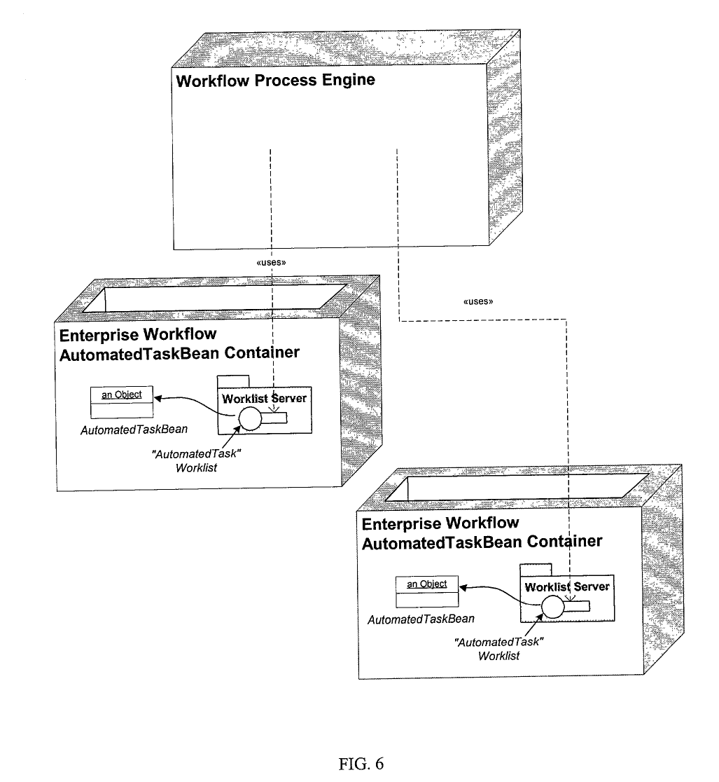

As those of ordinary skill in the art will readily appreciate, an EWATB Container that is fabricated in accordance with the present invention can be fabricated to work with any workflow system. As is well known to those of ordinary skill in the art, a typical workflow system comprises a workflow process engine and a worklist server. As long running process instances execute in the workflow process engine, they eventually reach an activity that must be processed. Typically, the name of the activity, along with its input parameters, is serialized to become a representation of an invocation of the Activity known as an Activity Instance or WorkItem. The WorkItem is then put onto a Worklist. As illustrated in FIG. 6, a single Workflow Process Engine may insert WorkItems into one of several Worklists. Thus, using a Worklist API provided by a workflow system vendor, external processes may interact with a Worklist Server by browsing a Worklist, retrieving WorkItems, processing the WorkItems, and providing a completed WorkItem back to the Worklist Server. Meanwhile, each WorkItem has a unique identifier, which unique identifier associates it with a specific, now-waiting, process instance. Whenever the Worklist Server receives a completed WorkItem, it sends the now-updated WorkItem back to the Workflow Process Engine where the waiting process instance may continue with the updated output values. Many workflow systems support a linear namespace of activity names and multiple output values for activity implementations. This causes some complexity that is overcome in accordance with one or more embodiments of the present invention.

As shown in FIG. 6, an EWATB Container fabricated in accordance with the present invention comprises an external Workflow System that is installed therein, which Workflow System comprises a Worklist Server subsystem. In accordance with this embodiment of the present invention, the EWATB Container automates the transformation of a WorkItem into an invocation of a method on an object, and transforms single return values from methods into multiple output values, if requested. Advantageously, in accordance with this embodiment of the present invention, custom Activity implementation developers do not need to code to any proprietary and complex Worklist API provided by the workflow system vendor.

An EWATB Container fabricated in accordance with the present invention includes the following: (a) a subsystem that gives dynamics to Enterprise AutomatedTaskBeans; (b) classes that support the invocation and execution of any object with methods representing an Enterprise AutomatedTaskBeanBean; and (c) an Enterprise AutomatedTaskBean deployment system.

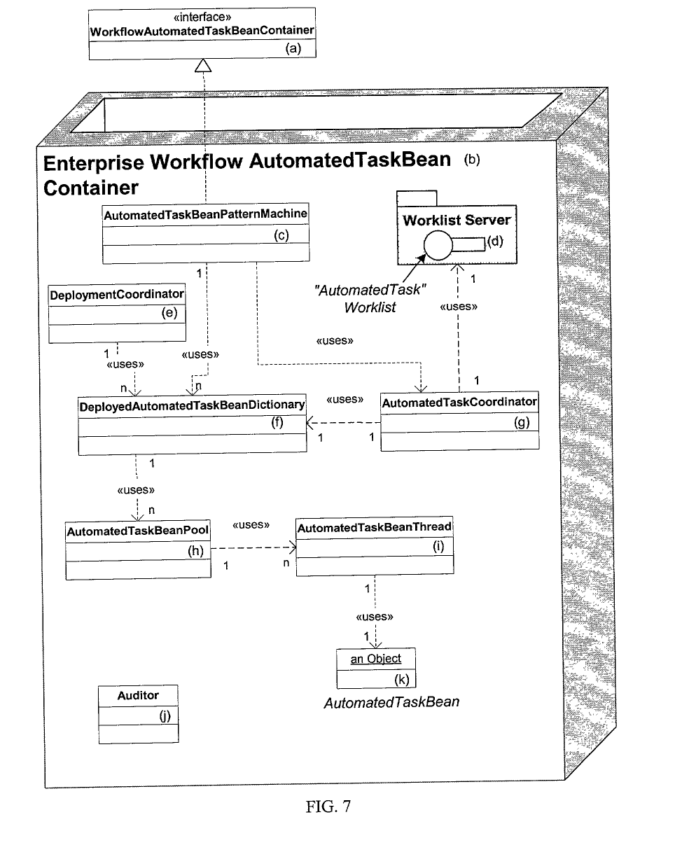

FIG. 7 shows a block diagram of software subsystems (along with their interrelationships) that comprise one embodiment of the present invention. In accordance with this embodiment of the present invention, Enterprise Workflow AutomatedTaskBean Container 7b manages Enterprise AutomatedTaskBeans and a single interface (WorkflowAutomatedTaskBeanContainer interface 7a) through which only administrative requests are made. As shown in FIG. 7, AutomatedTaskBeanPatternMachine 7c is the sole implementer of the single WorkflowAutomatedTaskBeanContainer interface 7a. Further, AutomatedTaskBeanPatternMachine 7c maintains responsibility to manage the life cycle of Enterprise AutomatedTaskBeans. In accordance with one embodiment of the present invention, embodiments of the inventive systems operate by implementing the following: (a) a component manager/component contract; (b) a client/container contract; and (c) a deployment contract.

As shown in FIG. 7, DeploymentCoordinator 7e drives a deployment system while AutomatedTaskBeanPatternMachine 7c drives client runtime. Together, DeploymentCoordinator 7e and AutomatedTaskBeanPatternMachine 7c initiate processing that may be declared using a deployment descriptor.

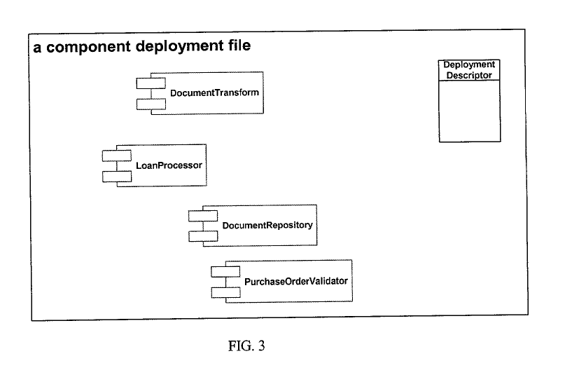

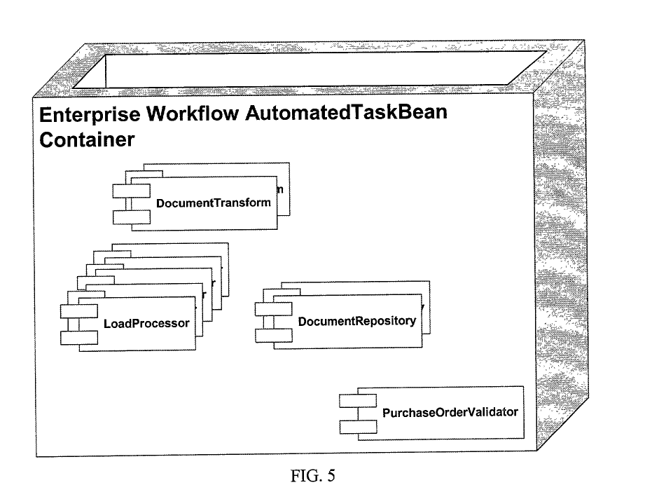

In accordance with this embodiment of the present invention, DeploymentCoordinator 7e receives a workflow automated task component deployment file utilizing any one of a number of methods that are well known to those of ordinary skill in the art. As will be described in detail below, the deployment file comprises one or more automated task components along with a deployment descriptor text file (see FIG. 3) that gives declarative instructions to EWATB Container 7b for each component. For example, and without limitation, DeploymentCoordinator 7e can poll a predetermined subdirectory of Enterprise Workflow AutomatedTaskBean Container 7b for the presence of a new deployment file, or DeploymentCoordinator 7e can be invoked directly by way of an Enterprise JavaBean SessionBean that represents DeploymentCoordinator 7e in accordance with methods that are well known to those of ordinary skill in the art. Then, in response, DeploymentCoordinator 7e reads each of the components in the new deployment file, along with their associated deployment descriptors. In accordance with this embodiment of the present invention, the components read by DeploymentCoordinator 7e may either be a class or a serialized component instance. However, whenever the component read is a class, the class is instantiated in accordance with methods that are well known to those of ordinary skill in the art. Nevertheless, in either case, DeploymentCoordinator 7e deploys a component by making an entry in DeployedAutomatedTaskBeanDictionary 7f. The component's deployment descriptor name is used as a key to AutomatedTaskBeanPool 7h—but with N copies of the component instance as shown in FIG. 7k where N is the maximum number of threads designated in the deployment descriptor for the component. In accordance with this embodiment of the present invention, EWATB Container 7b does not enable clients to access deployed automated task components (see FIG. 5 which shows a block diagram of typical Enterprise AutomatedTaskBeans of FIG. 3 that are deployed in an EWATB Container with a thread multiplicity that was designated in a Deployment Descriptor).

In accordance with this embodiment of the present invention, AutomatedTaskBeanPatternMachine 7c implements processing for all client interface invocations. For example, AutomatedTaskBeanPatternMachine 7c routes requests to the correct AutomatedTaskBeanPool based on the name of a component for which a request is intended. AutomatedTaskBeanPatternMachine 7c also manages several administrative functions through its AutomatedTaskBeanContainer interface 7a. For example, using AutomatedTaskBeanContainer interface 7a, AutomatedTaskBeanPatternMachine 7c causes the entire Enterprise AutomatedTaskBean Container 7b to be: (a) started; (b) shutdown; (c) queried for currently deployed AutomatedTask components; (d) requested to deploy additional component deployment files into the container; and (e) queried for historic occurrences (i.e., to provide an audit trail of various types) in accordance with methods that are well known to those of ordinary skill in the art.

As mentioned above, in accordance with the present invention, a AutomatedTaskBeanPool is instantiated, and N associated component instances are constructed for each component deployed. However, to do this, an AutomatedTaskBeanThread such as, for example, AutomatedTaskBeanThread 7i that encapsulates each component is constructed in accordance with methods that are well known to those of ordinary skill in the art. As such, each AutomatedTaskBeanThread object acts as a “wrapper” for a component. This wrapper is advantageously used so that an AutomatedTaskBeanPool can interact with each component in a more complex manner than the component was actually constructed to handle by itself. As one can readily appreciate, advantageously, this provides beneficial behavior that does not need to be coded by a component developer. For example, one embodiment of the AutomatedTaskBeanThread transforms WorkItems into an object and method invocation, and one embodiment of the AutomatedTaskBeanThread handles extraction of multiple output values from a single return value on the object method invoked. Further, in accordance with this embodiment of the present invention, and as shown in FIG. 7k, each AutomatedTaskBeanThread interacts with a single AutomatedTaskBean component as a standard object with methods.

In accordance with one embodiment of the present invention, AutomatedTaskCoordinator 7g is the exclusive subsystem for interacting with Worklist Server 7d. As such, it is the only class shown in FIG. 7 that must be coded to use a Worklist API provided by a workflow system vendor. In fact, in accordance with one embodiment of the present invention, multiple AutomatedTaskCoordinator classes may be constructed for different vendors so that an embodiment of the present invention will work with any vendor's Worklist Server.

In accordance with this embodiment of the present invention, using the Worklist API, AutomatedTaskCoordinator 7g polls a single, predetermined Worklist called, for example, “AutomatedTask,” for any WorkItems in accordance. Whenever this predetermined Worklist is empty, AutomatedTaskCoordinator 7g sleeps, and tries again later based, for example, on a configured polling interval in accordance with any one of a number of methods that are well known to those of ordinary skill in the art.

Whenever AutomatedTaskCoordinator 7g retrieves a WorkItem from Worklist Server 7d, it processes it (as described below) to get it ready for an implied method invocation. First, it extracts a name of the component for which the invocation is intended. For example, as is well known in the art, activities in workflow systems tend to have simple names in a linear name space. Since one embodiment of the present invention uses two names, i.e., a 2-tuple of (component name, method name), in such embodiment, the activity names employ a delimiter, for example, a period (or any other character allowed by the workflow system's naming system), to separate the two names that the embodiment uses from the single name that the workflow system thinks it is using. As a result, in accordance with this embodiment of the present invention, long running workflow processes think they are invoking activities with a single name, but in reality they are invoking single names of the form “<component name>.<method name>”. Thus, whenever AutomatedTaskCoordinator 7g retrieves a WorkItem from Worklist Server 7d, it extracts a single activity name, but then parses it to the delimiting character in order to obtain the component name and method name separately.

Using the component name, AutomatedTaskCoordinator 7g looks up an entry in DeployedAutomatedTaskBeanDictionary 7f. In response, AutomatedTaskCoordinator 7f obtains the AutomatedTaskBeanPool (for example, AutomatedTaskBeanPool 7h) corresponding to this name, and transfers to it the extracted method name to invoke, along with the WorkItem's parameters. In response, the AutomatedTaskBeanPool (for example, AutomatedTaskBeanPool 7h) invokes a free AutomatedTaskBeanThread (for example, AutomatedTaskBeanThread 7i) to handle the method name and its associated parameters. If no thread is free, then AutomatedTaskCoordinator 7g puts the WorkItem back on the Worklist for later.

Eventually, an AutomatedTaskBeanThread is invoked with the method name and parameters. As long as the class library of the target language and environment supports manipulation of class meta information, the AutomatedTaskBeanThread class can assemble an object that represents a method and invoke the actual object representing the automated task or activity implementation. In accordance with a preferred embodiment, Java's “java.lang.reflect” package is used for this processing.

Whenever the method completes, it returns an object. In accordance with one embodiment of the present invention, the deployment descriptor may have designated multiple output values for this method. If this is the case, the method element in the deployment descriptor will comprise one or more names of outputs. In such a case, the AutomatedTaskBeanThread extracts these outputs from the return value of the method by calling “property read” methods on the single object. The names of the property read methods may be formed, for example, by concatenating a string “get”+<output name> for each output name listed. A method with these names is then invoked on the single return object for each output name listed. The values obtained are then written to the associated WorkItem outputs. Then, the completed WorkItem is returned back to the AutomatedTaskBeanPool which then employs AutomatedTaskCoordinator 7g to hand it back to the Worklist Server in accordance with the API therefor.

Finally, AutomatedTaskCoordinator 7g, DeploymentCoordinator 7e, AutomatedTaskBeanPools (for example, AutomatedTaskBeanPool 7h), and AutomatedTaskBeanThreads (for example, AutomatedTaskBeanThread 7i) may all use Auditor class 7j in accordance with methods that are well known to those of ordinary skill in the art to record any salient occurrences in order to maintain an historic audit trail which may be queried any time later in accordance with methods that are well known to those of ordinary skill in the art.

The following describes the deployment of Enterprise AutomatedTaskBeans. In accordance with one embodiment of the present invention, one or more automated task components are packed into a single file, along with a deployment descriptor text file that provides declarative instructions for each component to the container. This file is deployed into the container in the manner described above. For example, as was described above, whenever an automated task component is deployed, the container automatically generates an object implementing a client interface and stores it in a directory service located at a name assigned to the automated task component in the deployment descriptor (see FIG. 3).

When automated task components have been coded, they are ready for deployment. In accordance with one embodiment of the present invention, in order to deploy one or more automated task components at the same time, their executable file forms are put into a single file such as a ZIP file or other file format that is able to maintain an internal directory structure and store one or more embedded files. Each automated task component may reside anywhere in the internal directory structure, and components may be grouped into the same or multiple deployment files for organizational purposes. An example of a component deployment file is shown in FIG. 3. Also shown in FIG. 3 is a text file known as a deployment descriptor that is located, for example, and without limitation, in an internal directory “META-INF”. The deployment descriptor provides deployment configuration instructions to the container for each automated task component. In accordance with a preferred embodiment of the present invention, XML is used to declare such deployment instructions. Specifically, deployment instructions for each automated task component comprises: a string designating a directory name for the component (for example, its JNDI name); a string designating an internal deployment file path name to a file containing executable code for the component; a string designating an internal deployment file path name to a serialized state of an instance; a string designating a name of the component model (for example, Java, Microsoft COM, CORBA, or any other component models); an integer designating a maximum number of threads that the EWATB Container will construct for the component, strings designating names of methods to be made available for automated task invocation; additional strings per method declaring names of parameters; and additional strings per method declaring names of two or more outputs for cases where there is more than one output.

In accordance with one embodiment of the present invention, Enterprise AutomatedTaskBeans may be stored in Enterprise AutomatedTaskBean JAR files also referred to herein as “EWATB JAR” files (the configuration of the Enterprise AutomatedTaskBeans described by an EWATB Deployment Descriptor is also included within the EWATB JAR file). Advantageously, this embodiment enables Enterprise AutomatedTaskBeans to be saved, and then deployed at any time.

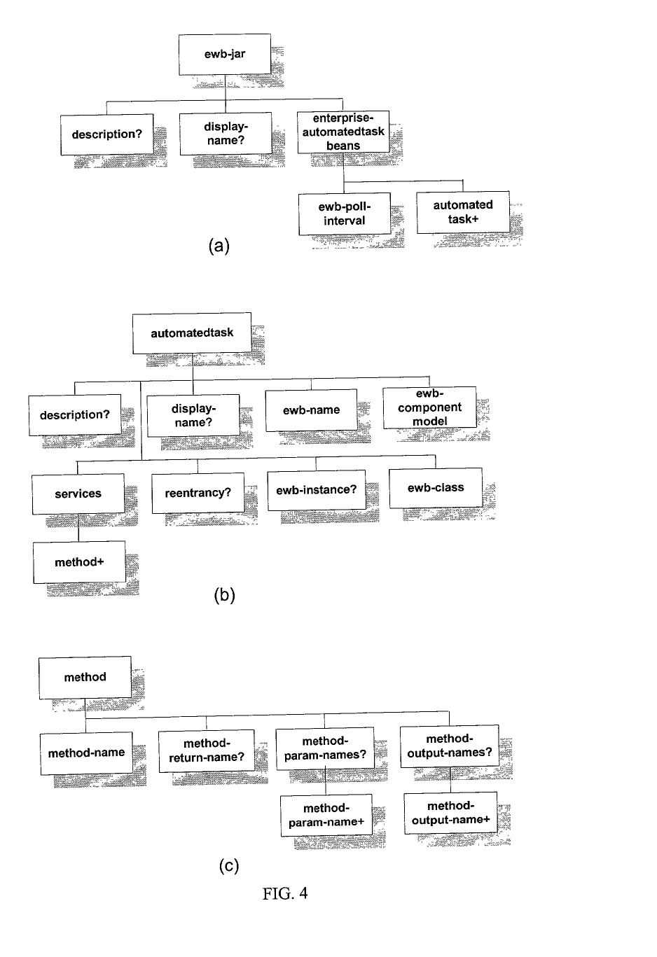

FIG. 4 shows a block diagram of an XML grammar structure of an EWATB JAR that is fabricated in accordance with the present invention, wherein FIGS. 4b and 4c show deployment instructions for an automated task component and its associated method element, respectively.

The following describes EWATB JAR Resource files. In accordance with one embodiment of the present invention, there are three categories of resource files: (a) category 1 relates to support files (for example, external native programs or configuration files); (b) category 2 relates to JNI native libraries (for example, d11 or so files); and (c) category 3 relates to class and Java files.

Category 1 files are stored in a JAR in a directory that corresponds to the bean name. For example, resources for the bean: wat.verano.ewatb_bean.satellite.SatelliteReceiverBean should be stored in the JAR at resources/wat/verano/ewatb_bean/satellite/SatelliteReceiverBean/. All files and any files in any subdirectories under this location will be extracted to %EWATB_HOME%/respository/resources/wat/verano/ewatb_bean/satellite/SatelliteReceiverBean/ where %EWATB_HOME% is the directory that the EWATB Container was installed.

Category 2 files are stored in a similar location. For the bean wat.verano.ewatb_bean.satellite.SatelliteReceiverBean native libraries should be stored in the JAR at resources/wat/verano/ewatb_bean/satellite/SatelliteReceiverBean/native. All files in this location are extracted to %EWATB_HOME %/repository/resources/native/SatelliteReceiverBean/<JAR_DATE>/ where <JAR_DATE> is the date and time the jar was created.

Category 3 files are stored in the JAR normally and according to the JavaBean specification.

The following describes how files are extracted at deployment time. In accordance with one embodiment of the present invention, resource files will be extracted from a JAR at deployment time or at EWATB Container start time. If a resource file already exists, the file will be overwritten if the JAR was created after the last modified date of the file. Thus, if one modifies the file and then starts the EWATB Container, the file will not be overwritten, However, if one deploys a newer version of the JAR, the file will be overwritten. At undeployment time (i.e., whenever the JAR is deleted) the resource files will be deleted. In addition, if the deployment descriptor does not include a bean's information, the bean's support files will not be extracted from the JAR file.

In accordance with one embodiment of the present invention, an Enterprise AutomatedTaskBean locates its support files at runtime by appending the bean name to a path to the location of a resources directory. For example, in one embodiment of the present invention, a system Java property variable “ewatb.workarea” is set to the location of the resources directory. For example, %EWATB_HOME%/repository/resources.

Those skilled in the art will recognize that the foregoing description has been presented for the sake of illustration and description only. As such, it is not intended to be exhaustive or to limit the invention to the precise form disclosed. For example, although embodiments of the present invention have been described using component managers which comprise Enterprise Workflow AutomatedTaskBean Containers and using components which comprise Enterprise AutomatedTaskBeans, those of ordinary skill in the art should readily appreciate that the present invention is not limited to such embodiments. In fact, it is within the spirit of the present invention to include any embodiment of component managers and components. For example, in some embodiments, automated task components may be any objects that support the execution of one or more associated methods as, for example, in object oriented programming.

Those skilled in the art will recognize that the foregoing description has been presented for the sake of illustration and description only. As such, it is not intended to be exhaustive or to limit the invention to the precise form disclosed.

What is claimed is:

1. A component manager that manages one or more workflow automated task components that implement an automated task in a workflow process definition running in a workflow engine, the component manager comprising:
a work coordinator that reads a workitem from a worklist in the workflow system; and obtains a name of an automated task component and a method to invoke and workitem parameters; and
a task translator that converts the workitem parameters into a method invocation on an automated task component instance representing the automated task; and
wherein the work coordinator synchronously waits for an invocation response before it updates the workitem in the worklist.

2. The component manager of claim 1:
wherein the work coordinator extracts multiple output values from an object returned from the automated task component method to update multiple outputs represented in the workitem.

3. The component manager of claim 1 further comprises a software component to operate on components implemented in one of the following component models: Javabeans, Microsoft COM, and CORBA.

4. The component manager of claim 1 further comprises:
a data extractor that identifies named fields on a returned result object that can be extracted from the returned result object and submitted as multiple output parameters to update multiple workitem attributes.

5. The component manager of claim 1 further comprises:
an invoker that invokes an automated task component method whose name identifies an automated task component class; and
a class instatiator that instantiates the identified automated task component class prior to being invoked.

6. The component manager of claim 1 wherein the invoker further comprises:
an asynchronous invoker that invokes an automated task component method asynchronously whenever the method has no result to return; and
wherein the work coordinator does not wait for a response before it updates the workflow processor to inform it that it may proceed.

7. The component manager of claim 1 further comprises:
a deployer that reads and deploys a file including component classes in the component manager.

8. The component manager of claim 7 further comprises:
a deployer that reads and deploys a file including component instances in the component manager.

9. The component manager of claim 7 wherein the deployer further comprises:
a deployment descriptor interpreter that reads a deployment descriptor included in the file wherein a maximum number of threads per automated task component protocol may be declared to the component manager.

10. The component manager of claim 7 wherein the deployment descriptor interpreter further comprises:
declares a polling interval of the work coordinator to read a worklist for workitems.
